(19) United States
(12) Patent Application Publication
(10) Pub. No.: US 2015/0355668 A1
(43) Pub. Date: Dec. 10, 2015

(54) CONTROL DEVICE HAVING PULL-OUT RESISTANCE

(71) Applicants: CONTINENTAL AUTOMOTIVE FRANCE, Toulouse (FR); CONTINENTAL AUTOMTOTIVE GMBH, Hannover (DE)

(72) Inventors: Jean-Philippe BEKAERT, Montigny Le Bretonneux (FR); Gilles LE ROY, Rambouillet (FR)

(21) Appl. No.: 14/763,208

(22) PCT Filed: Feb. 14, 2014
(86) PCT No.: PCT/EP2014/000415

§ 371 Date: Jul. 24, 2015

(30) Foreign Application Priority Data
Feb. 19, 2013 (FR) 1351404

(51) Int. Cl. G05G 1/12

(52) U.S. Cl. CPC G05G 1/12

(57) ABSTRACT

Control device, including a switch (60) having a body (6) and a control rod (1) extending along an axis (A) to an end (19), a button (2) made of molded plastic including an axial recess (12) of the axis, for receiving the control rod, an anchoring part (3) made of cut and folded sheet metal including a transverse portion (30) interposed between the end of the control rod and a shoulder of the axial recess of the button, the anchoring part including a plurality of first claws (4), directed away from the body and oriented at an angle in the direction of the axis and bearing against the control rod, and a plurality of second claws (5), directed toward the body and oriented at an angle away from the axis, the second claws bearing against the button so as to prevent any removal of the button following insertion.

The present invention relates to control devices having pull-out resistance, in particular to control devices for controlling the operation of one or a plurality of components of a motor vehicle by an operator.

It relates more particularly to a control device comprising a switch having a body and a control rod extending along an axis A, said control rod being made from a plastic material and being mounted at least with one degree of freedom in relation to the body, and the control device comprising a button made of molded plastic comprising an axial recess of the axis A, in which the control rod is received.

It is known according to the prior art, for example from document JP 2005 064 083 A, to provide a helical spring in order to tighten the button around the control rod. This embodiment has the following disadvantages, however: either the pull-out resistance of the button is insufficient (helical spring not tightened sufficiently and insufficiently active), or the effort of inserting the button is too great (helical spring over tightened and over active).

In order to address these shortcomings, the applicant now proposes a device comprising:
a switch having a body and a control rod extending along an axis as far as an end, said control rod being made of plastic material and being mounted at least with one degree of freedom in relation to the body,
a button made of molded plastic comprising an axial recess, in which the control rod is received at least in part,
an anchoring part made of cut and folded sheet metal.
The anchoring part comprises a transverse portion interposed between the end of the control rod and a shoulder of the axial recess of the button, and the anchoring part comprises a plurality of first claws, directed away from the body, oriented at an angle in the direction of the axis and bearing against the control rod, and a plurality of second claws, directed toward the body and oriented at an angle away from the axis, said second claws bearing against the button.

Thanks to these provisions, the resistance of the button to being pulled out by an operator is high, whereas the effort of inserting the anchoring part and the button are moderate. In fact, the anchorage and the bracing of the first and second claws, which function as harpoons, make withdrawal of the button very difficult, whereas in the direction of insertion the first claws slide on the control rod and the button is able to slide easily on the second claws.

In various embodiments of the invention, one may possibly resort in addition to one and/or other of the following provisions:
the anchoring part may have at least three tabs, on which the first and second claws are arranged, each of the tabs being substantially flat, arranged parallel to the axis A, extending at a right angle from the transverse portion and being interposed radially between the button and the control rod. In this way, the tabs form an adequate interface between the control rod and the button; this is also favorable in order to maintain good centering of the button in relation to the control rod, the three tabs preferably being well distributed circumferentially;
each of the three tabs includes at least one first claw and one second claw, such that each tab alone produces a pull-out resistant effect. The axial dimensions necessary for the pull-out resistant function may be very small as a result;
each of the three tabs includes a plurality of first and second claws, arranged in two axially offset rows, preferably alternating in each row, such that the forces experienced in the event of traction on the button are well distributed. The pull-out resistance performance is thus particularly optimized;
the first and second claws are obtained by stamping from a flat blank including at least three radial branches extending from a central portion, after which the radial branches of the blank are folded back at a right angle in order to form said tabs, and the central portion then forms the transverse portion. The anchoring part formed in this way is very easy to produce by metal cutting by means of a conventional follow-on tool;
the button comprises flexible walls having a substantially flat front face. The insertion of the button on the anchoring part is facilitated in this way and requires a minimal effort;
the first claws and the second claws form a rasp to either side of the tab, such that the stamping operation to obtain the first and second claws is a well-managed process;
the first claws include a cut edge to help the penetration of the claw into the control rod, and/or the second claws include a cut edge to help the penetration of the claw into the interior surface of the flexible walls, by means of which it is possible to take advantage of a phenomenon of the forming operation in order to strengthen the ability of the claws to be attached to the opposing component;
the at least one degree of freedom is a rotation about the axis A. This is the case for a rotary switch, the latter being capable of being provided, or of not being provided, with another degree of freedom;
the control rod may be substantially smooth and may have a projection distance from the body of less than 7 mm, preferably with a flat surface, such that the axial projection of the button is limited and the attachment zone is effective although not very high;
the switch in question is an electrical or electronic switch configured to control the operation of one or a plurality of components of a motor vehicle by an operator.

Other aspects, aims and advantages of the invention will be appreciated from a perusal of the following description of one of its embodiments, which is given by way of non-exhaustive example. The invention will also be better understood in the light of the accompanying drawings, in which:

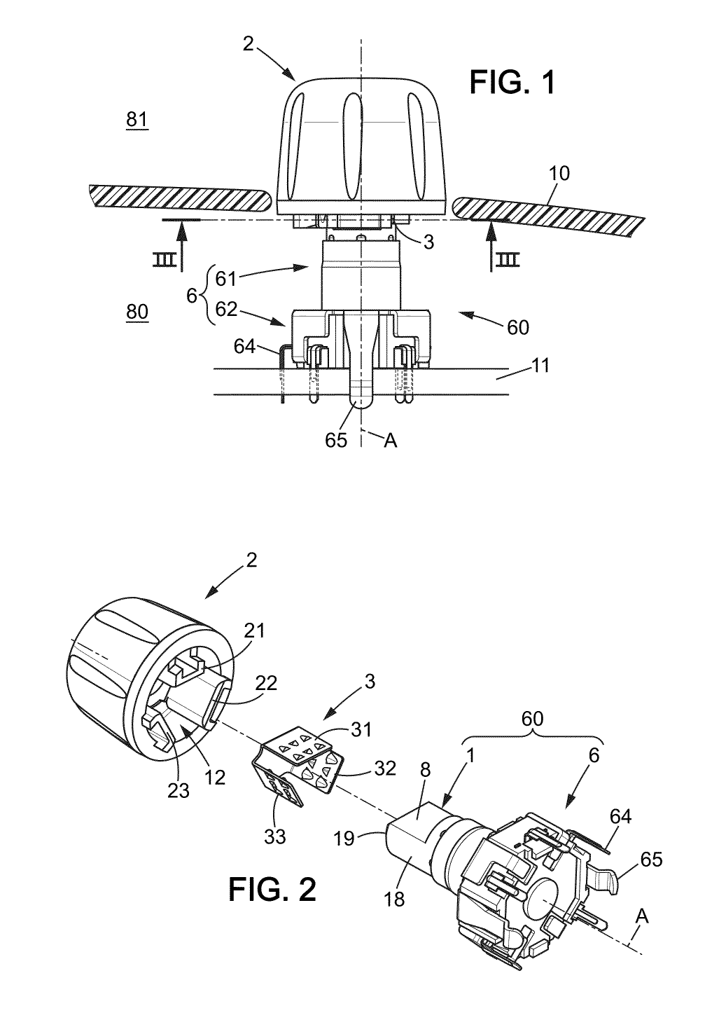

FIG. 1 depicts schematically a control device according to the invention, integrated into a control assembly,

FIG. 2 depicts an exploded view in perspective of the control device in FIG. 1,

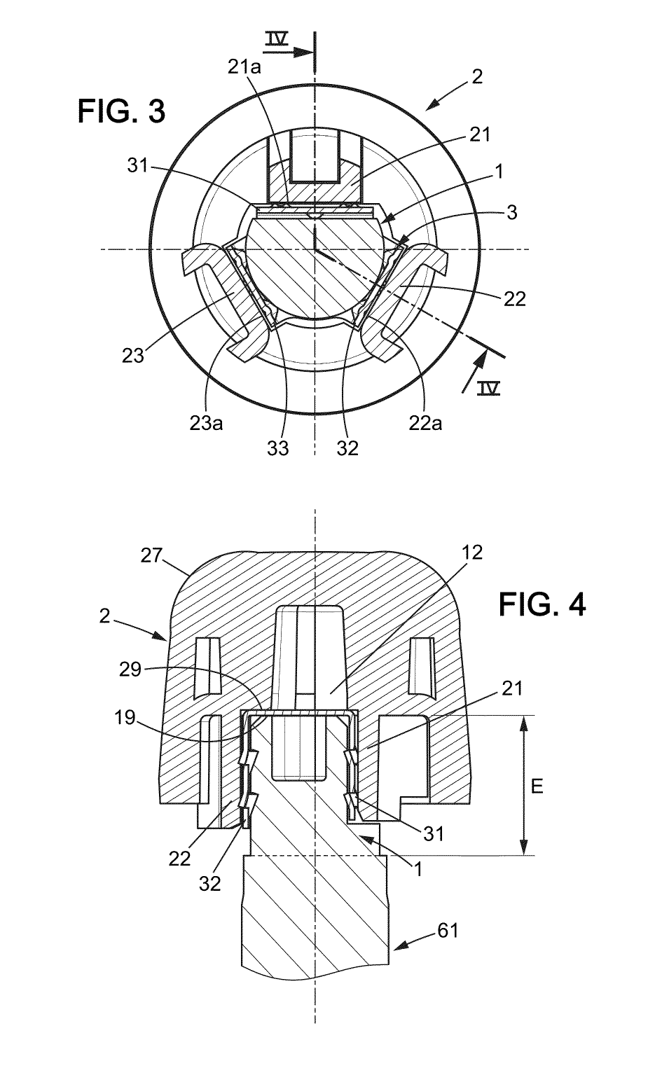

FIG. 3 shows a transverse section of the device along the line III-III in FIG. 1,

FIG. 4 shows a longitudinal section of the device along the line IV-IV in FIG. 3,

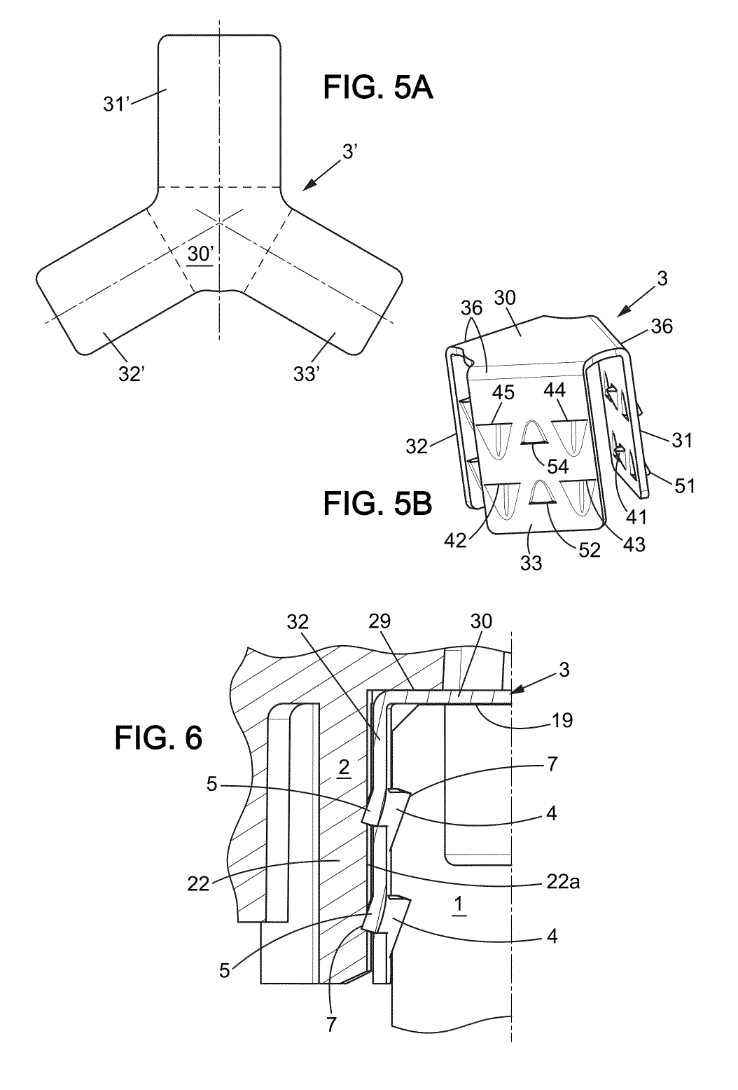

FIGS. 5A and 5B depict the anchoring part before and after forming, and

FIG. 6 depicts a detail of the contacts between the anchoring part, the button and the control rod.

The same references are used in the different figures to designate identical or similar elements.

FIG. 1 depicts a control assembly, into which a control device according to the invention is integrated. The control assembly comprises a switch 60 mounted on an electronic card 11.

A front wall 10 separates an interior space 80 comprising the electronic card 11 from an external space 81, known as the operator space, in which an operator may be present. Said operator may operate the switch 60 by means of a button 2, which projects from the front wall 10 toward the operator space 81.

The button 2 extends from the electronic card 11 along an axis A, which may be referred to as the principal axis of the switch 60.

The switch 60 comprises a body 6 having a base plate 62 and a collar 61. A control rod 1 is mounted on this body 6. In the illustrated example, this is an assembly that is capable of rotating about the axis A having a path in the axial direction.

In general, the control rod 1 is mounted with at least one degree of freedom, which may be, for example although not exclusively, a rotation about the axis A as in the case of an encoder or a rotary switch, or said degree of freedom may be a translation in parallel to A, as in the case of a push button or a button of the ‘push-pull’ type. The invention may also be applied to an assembly of the “joystick” or joystick scroll wheel type.

As visible in FIGS. 1 to 6, the switch 60 comprises the control rod 1 mounted in relation to the body 6. The base plate 62 is equipped with mounting feet 65 which are accommodated in holes in the electronic card 11 and which serve for positioning and holding prior to the welding of the electrical contact pins 64 on the lower face of the electronic card 11.

The control rod 1 is present in the illustrated example as a cylindrical rod, arranged on which is a zone with a flat surface 8, conventionally being a plane zone.

A complementary peripheral zone 18 depicts the circumferential complement of the zone with a flat surface. The control rod 1 extends as far as an end 19, which forms its axial extremity and which is not necessarily a plane surface.

The aforementioned button 2 comprises a gripping zone 27 having the general form of a bell and having concave forms on the external surface, an axial recess 12 generally being centered on the axis A. Arranged in this axial recess 12 is a shoulder 29 provided in order to serve as a stop to the axial movement in the course of assembly.

In addition, the button 2 comprises flexible walls 21, 22, 23 intended to provide a mechanical interface in relation to the control rod 1, among which are a first wall 21 intended to be positioned opposite the zone with the flat surface 8, and at least two second walls 22, 23 intended to be positioned opposite the complementary peripheral zone 18. Each of the flexible walls has a front face 21a, 22a, 23a that is substantially plane and is oriented toward the axis, and the normal to this face may preferably pass through the axis A. The flexible walls are arranged in an internal space of the gripping zone 27 of the button; they are preferably distributed around the axis in a balanced manner, at 120° one from the other in the illustrated example.

An anchoring part 3 is intended to be interposed between the button 2 and the control rod 1, said anchoring part serving as a mechanical interface both for the positioning and for the pull-out resistant function between the button 2 and the control rod 1.

The anchoring part 3 is made of cut and folded sheet metal; in particular any steel that is suitable for fine cutting by a follow-on tool, for example a stainless steel or a coated sheet, may be selected.

As illustrated in particular in FIG. 5B, the anchoring part 3 comprises a transverse portion 30 extending in a plane perpendicular to the axis A, and three tabs 31, 32, 33 extending at a right angle from the transverse portion. Each of the three tabs 31, 32, 33 is arranged substantially flat in parallel to the axis A, the tabs preferably being distributed around the axis in a balanced manner, at 120° one from the other in the illustrated example, in such a way as to face the aforementioned flexible walls 21, 22, 23. The number of tabs may be different, of course, for example greater than three or even equal to two.

The anchoring part 3 may be obtained thanks to a follow-on forming tool. In order to do this, as illustrated in FIG. 5A, before forming, the starting point is a precut flat blank 3′ of constant thickness (thickness between 0.1 mm and 0.5 mm) including three rectangular radial branches 31′, 32′, 33′ extending from a central portion 30′. Flat stamping is then performed in order to create first claws 4 and second claws 5 to either side of the flat blank 3′. A die and a punch each comprise slightly protruding projections in order to generate stamped forms. The depth of these stamped forms is well-managed, and the cost of the die and punch tools is moderate, because working takes place substantially in a single plane.

After this, the branches 31′, 32′, 33′ are folded back at a right angle in order to form the aforementioned tabs 31, 32, 33, and the central portion 30′ then forms the transverse portion 30, connected to each of the tabs by an elbow line 36.

The first and second claws 4, 5 are formed as harpoons in order to permit an attachment in one direction and sliding in the opposite direction.

It should be noted that the stamping operation intended to create the claws permits pointed edges 7 to be obtained, which are visible in particular in FIG. 6, in order to improve the attachment function of the harpoon function.

After forming and assembly, as illustrated in FIGS. 3, 4 and 6, the first claws 4 are arranged toward the interior of the anchoring part 3, being oriented at an angle in the direction of the axis A and directed away from the body 6. These first claws 4 each have a sharp edge 7 bearing against the control rod 1.

Furthermore, the second claws 5 are arranged toward the exterior of the anchoring part 3, being oriented at an angle away from the axis A and directed toward the body 6. These second claws 5 may also each have a sharp edge 7 bearing against the button 2.

In a variant embodiment that is not depicted here, the first claws 4 and/or the second claws 5 may also have a certain elasticity in order to facilitate assembly.

The transverse portion 30 is sandwiched between the end 19 of the control rod 1 and the aforementioned shoulder 29.

It should be noted that the first tab 31 as well as the first wall 21 are closer to the axis A than the other tabs and the other walls, due to the presence of the flat surface 8 against which they bear. A coding is accomplished in this way in order to permit only a single position for the anchoring ring 3 on the control rod 1 and only a single assembly position of the button 2.

If an operator attempts to pull out the button 2, the pulling force is transmitted by the button 2 toward the anchoring part 3 by the second claws 5, which prevent the displacement of the button 2 toward the extremity 19 of the control rod 1; the effort exerted being distributed over the plurality of the second projections arranged all the way around the axis.

The force experienced by the anchoring part 3 is transmitted to the control rod 1 by means of the first claws 4. These first claws 4 are braced on the control rod 1, which makes any withdrawal practically impossible, at least if an attempt is made to pull out the button 2 by hand. Each of the three tabs 31, 32, 33 includes at least one first claw 4 and one second claw 5, in such a way as to achieve the right balance in the distribution of the forces around the axis A.

Advantageously according to one aspect of the invention, each of the tabs 31, 32, 33 comprises a plurality of first and second claws arranged in two axially offset rows, preferably alternating on each row. In this way, each of the tabs 31, 32, 33 may be considered to form a rasp on each of its two faces.

As illustrated in particular in FIG. 5B, the first tab 31 comprises two first claws 41 and four second claws 51, distributed in two rows, each row containing a first claw 41 surrounded by two second claws 51.

The third tab 33 comprises four first claws 42, 43, 44, 45 and two second claws 52, 54 distributed in two rows, each row containing a second claw surrounded by two first claws. The second tab 32 is similar to the third tab 33.

According to an optional aspect of the present invention, the control rod 1 is substantially smooth, and the hardness of its surface is not too high to permit the attachment of the edges of the first claws 4. In addition, the control rod 1 has a projection distance E from the body of less than 7 mm, which allows for a limited space along the axial direction A, and/or a limited projection of the button in relation to the front wall 10.

It should also be noted that the button 2 may be of two-material one-piece, or multi-piece configuration. In the case of the two-material configuration, an elastomer compound may be selected for the gripping zone 27 and a harder plastic for the base which comprises the walls 21, 22, 23. However, the hardness of the surface of the walls must not be too high in order to help the attachment of the second claws 5.

According to an optional aspect of the present invention, the axial recess 12 of the button 2 is blind, the gripping zone 27 not exhibiting any edge or junction which may be unsightly. It should be noted that the shoulder 29 may be combined with the base of the axial recess 12, or may be clearly offset as illustrated in the figures.

The possibility of the button 2 containing other functions, such as a light guide for a luminous identification at the surface, is not excluded.

Advantageously, according to one aspect of the invention, the slight projection of the button 2 in relation to the front wall 10 makes it possible to conform to the requirements of the automobile industry known as ECE21, which concerns the protection of the occupants in the event of impact. In addition, the material of the gripping zone may be selected to have a hardness below 50 Shores.

The method for assembling the switching device is the following:
i. an anchoring part 3 is formed from a flat metallic blank 30′, as described above,
ii. the anchoring part 3 thus formed is installed on the control rod 1 by pressing the transverse portion 30 against the end 19 of the control rod 1,
iii. the button 2 is inserted onto the control rod 1 equipped with the anchoring part 3 until the shoulder 29 comes into abutment against the transverse portion 30.

During stage ii., the first claws 4 slide along the external surface of the control rod 1.

During stage iii., the front faces of the flexible walls 21, 22, 23 slide along the second claws 5.

After stage iii., an attempt to go back will bring about the anchorage and the bracing of the first claws 4 and second claws 5 as described previously.

According to the present invention, the switch 60 is not necessarily an electrical switch, but it may be a mechanical switch, for example for controlling a cable.

1. A control device, comprising:
a switch (60) having a body (6) and a control rod (1) extending along an axis (A) as far as an end (19), the control rod (1) being made of a plastic material and being mounted at least with one degree of freedom in relation to the body (6),
a button (2) made of molded plastic comprising an axial recess (12) of the axis (A), in which the control rod (1) is received at least in part,
an anchoring part (3) made of cut and folded sheet metal,
the anchoring part (3) comprising a transverse portion (30) interposed between the end of the control rod (1) and a shoulder (29) of the axial recess (12) of the button (2), and the anchoring part (3) comprising a plurality of first claws (4), directed away from the body (6), oriented at an angle in the direction of the axis (A) and bearing against the control rod (1), and a plurality of second claws (5), directed toward the body (6) and oriented at an angle away from the axis (A), said second claws (5) bearing against the button (2).

2. The control device as claimed in claim 1, in which the anchoring part (3) has at least three tabs (31, 32, 33) on which the first and second claws are arranged, each of the tabs being substantially flat and being arranged parallel to the axis (A), extending at a right angle from the transverse portion (30) and being interposed radially between the button (2) and the control rod (1).

3. The control device as claimed in claim 2, wherein each of the three tabs (31, 32, 33) includes at least one first claw (4) and one second claw (5).

4. The control device as claimed in claim 2, wherein each of the three tabs (31, 32, 33) includes a plurality of first and second claws arranged in two axially offset rows, preferably alternating in each row.

5. The control device as claimed in claim 1, wherein the first and second claws are obtained by stamping from a flat blank (3′) including at least three radial branches (31′, 32′, 33′) extending from a central portion (30′), after which the radial branches (31′, 32′, 33′) are folded back at a right angle in order to form said tabs (31, 32, 33), and the central portion (30′) then forms the transverse portion (30).

6. The control device as claimed in claim 1, wherein the button (2) comprises flexible walls (21, 22, 23) having a substantially flat front face (21a, 22a).

7. The control device as claimed in claim 1, wherein the first claws (4) and the second claws (5) form a rasp to either side of the tab.

8. The control device as claimed in claim 1, wherein the at least one degree of freedom is a rotation about the axis (A).

9. The control device as claimed in claim 1, wherein the control rod (1) is substantially smooth and has a projection distance (E) from the body of less than 7 mm, preferably with a flat surface (8).

10. The control device as claimed in claim 1, wherein the switch (60) is an electrical or electronic switch configured to control the operation of one or a plurality of components of a motor vehicle by an operator.

11. The control device as claimed in claim 2, wherein the first and second claws are obtained by stamping from a flat blank (3′) including at least three radial branches (31′, 32′, 33′) extending from a central portion (30′), after which the radial branches (31′, 32′, 33′) are folded back at a right angle in order to form said tabs (31, 32, 33), and the central portion (30′) then forms the transverse portion (30).

12. The control device as claimed in claim 3, wherein the first and second claws are obtained by stamping from a flat blank (3′) including at least three radial branches (31′, 32′, 33′) extending from a central portion (30′), after which the radial branches (31′, 32′, 33′) are folded back at a right angle in order to form said tabs (31, 32, 33), and the central portion (30′) then forms the transverse portion (30).

13. The control device as claimed in claim 2, wherein the button (2) comprises flexible walls (21, 22, 23) having a substantially flat front face (21a, 22a).

14. The control device as claimed in claim 3, wherein the button (2) comprises flexible walls (21, 22, 23) having a substantially flat front face (21a, 22a).

15. The control device as claimed in claim 2, wherein the first claws (4) and the second claws (5) form a rasp to either side of the tab.

16. The control device as claimed in claim 2, wherein the at least one degree of freedom is a rotation about the axis (A).

17. The control device as claimed in claim 2, wherein the control rod (1) is substantially smooth and has a projection distance (E) from the body of less than 7 mm, preferably with a flat surface (8).

18. The control device as claimed in claim 2, wherein the switch (60) is an electrical or electronic switch configured to control the operation of one or a plurality of components of a motor vehicle by an operator.
